(19) United States
(12) Patent Application Publication
(10) Pub. No.: US 2014/0348141 A1
(43) Pub. Date: Nov. 27, 2014

(54) Method for Transmitting Control Signaling, User Equipment, and Base Station

(71) Applicant: Huawei Technologies Co., Ltd., Shenzhen (CN)

(72) Inventors: Mingyu Zhou, Shenzhen (CN); Chi Gao, Beijing (CN); Liang Xia, Shenzhen (CN)

(21) Appl. No.: 14/335,151

(22) Filed: Jul. 18, 2014

Related U.S. Application Data
(63) Continuation of application No. PCT/CN2012/085036, filed on Nov. 22, 2012.

(30) Foreign Application Priority Data
Jan. 19, 2012 (CN) 201210017577.4

(51) Int. Cl. H04W 72/04

(52) U.S. Cl. CPC H04W 72/042
USPC 370/336; 370/329

(57) ABSTRACT

Embodiments of the present invention provide a method for transmitting control signaling. A base station determines a modulation mode adopted for one group of resources among multiple groups of resources. Different modulation modes are adopted for at least two groups of resources among the multiple groups of resources. The base station uses the modulation mode adopted for the one group of resources to modulate control signaling sent on the one group of resources. The base station sends the modulated control signaling to a UE on the one group of resources.

This application is a continuation of International Application No. PCT/CN2012/085036, filed on Nov. 22, 2012, which claims priority to Chinese Patent Application No. 201210017577.4, filed on Jan. 19, 2011, both of which are incorporated herein by reference in their entireties.

### TECHNICAL FIELD

Embodiments of the present invention relate to the field of communications technologies, and in particular, to a method for transmitting control signaling, a user equipment, and a base station.

### BACKGROUND

In a communication system, in order to implement flexible scheduling, a base station needs to dynamically send control signaling to a user equipment. For example, the base station generally determines, according to a channel change, a proper scheduling solution, which includes a modulation mode, an encoding rate, a space transmission solution and/or a power control solution, and so on, and sends information including the scheduling solution to a UE through control signaling; and the UE performs corresponding sending or receiving according to the control signaling. These scheduling solutions are determined in real time according to channel conditions, so that reliability and effectiveness of transmission can be improved.

In an LTE system, a channel that bears control signaling sent by a base station to a UE is referred to as a physical downlink control channel (PDCCH), and the base station may send control signaling at each transmission time interval (TTI). Specifically, after modulating the control signaling according to a certain fixed modulation mode, the base station maps the modulated control signaling to all subcarriers of the first N symbols of the TTI.

The time length of one TTI is 1 ms, which includes 14 orthogonal frequency division multiplexing (OFDM) symbols, one symbol in the terms of time and one subcarrier in the terms of frequency are referred to as one resource element (RE); and one TTI in the terms of time and 12 subcarriers in the terms of frequency collectively form one physical resource block (PRB). In the TTI, except for N symbols used in the PDCCH, other symbols may be used for transmitting a physical downlink shared channel (PDSCH). A modulation mode of the PDCCH in the system is quadrature phase shift keying (QPSK), so as to ensure reliability of transmission of the PDCCH.

After the base station sends the PDCCH in this manner, in the corresponding first N symbols, the UE may obtain the PDCCH sent by the base station to the UE in a blind detection manner. In the process, the UE performs demodulation according to a QPSK demodulation mode, so that the UE may obtain the control signaling sent by the base station to the UE.

In addition, a new PDCCH transmission manner is further provided, and the base station transmits a PDCCH and a PDSCH on different PRBs.

In the prior art, a fixed QPSK modulation mode is adopted to modulate a PDCCH, but one QPSK symbol can bear only two information bits, and therefore efficiency is quite low.

### SUMMARY

Embodiments of the present invention provide a method for transmitting control signaling, a user equipment, and a base station, which can improve efficiency of transmitting control signaling.

In one aspect, a method for transmitting control signaling is provided and includes: determining, by a base station and according to a preset rule, a modulation mode adopted for one group of resources among multiple groups of resources, where different modulation modes are adopted for at least two groups of resources among the multiple groups of resources; modulating, by the base station by using the modulation mode adopted for the one group of resources, control signaling sent on the one group of resources; and sending, by the base station, the modulated control signaling to a user equipment UE on the one group of resources.

In another aspect, a method for transmitting control signaling is provided and includes: receiving, by a user equipment UE, modulated control signaling from a base station on one group of resources among multiple groups of resources; determining, by the UE and according to a preset rule, a modulation mode adopted for the one group of resources, where different modulation modes are adopted for at least two groups of resources among the multiple groups of resources; and demodulating, by the UE by using the modulation mode adopted for the one group of resources, the modulated control signaling to obtain control signaling.

In another aspect, a base station is provided and includes: a determining module, configured to determine, according to a preset rule, a modulation mode adopted for one group of resources among multiple groups of resources, where different modulation modes are adopted for at least two groups of resources among the multiple groups of resources; a modulating module, configured to modulate, by using the modulation mode adopted for the one group of resources, control signaling sent on the one group of resources; and a sending module, configured to send the modulated control signaling to a user equipment UE on the one group of resources.

In another aspect, a user equipment is provided and includes: a determining module, configured to receive modulated control signaling from a base station on one group of resources among multiple groups of resources; a receiving module, configured to determine, according to a preset rule, a modulation mode adopted for the one group of resources, where different modulation modes are adopted for at least two groups of resources among the multiple groups of resources; and a demodulating module, configured to demodulate, by using the modulation mode adopted for the one group of resources, the modulated control signaling to obtain control signaling.

The technical solutions may provide multiple optional modulation modes for control signaling sent by a base station to a UE, so that the base station can flexibly select, according to a preset policy, a different modulation mode to process a PDCCH, thereby improving efficiency of transmitting control signaling.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a flow chart of a method for transmitting control signaling according to an embodiment of the present invention;

FIG. 2 is a flow chart of a method for transmitting control signaling according to another embodiment of the present invention;

FIG. 3 is a schematic flow chart of a process of transmitting control signaling according to an embodiment of the present invention;

FIG. 4 is a schematic diagram of a search space of a UE according to an embodiment of the present invention;

FIG. 5 is a schematic structural diagram of a base station according to an embodiment of the present invention; and

FIG. 6 is a schematic structural diagram of a user equipment according to an embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Apparently, the embodiments to be described are merely a part rather than all of the embodiments of the present invention. All other embodiments obtained by persons of ordinary skill in the art based on the embodiments of the present invention without creative efforts shall fall within the protection scope of the present invention.

It should be understood that, the technical solutions of the present invention are applicable to various communication systems, such as: a global system of mobile communication (GSM), a code division multiple access (CDMA) system, a wideband code division multiple access (WCDMA) system, a general packet radio service (GPRS) system, a long term evolution (LTE) system, a long term evolution advanced (LTE-A) system, and a universal mobile telecommunication system (UMTS), which are not limited in the embodiments of the present invention. But for ease of description, the embodiments of the present invention are described by taking an LTE network as an example.

The embodiments of the present invention may be used in radio networks with different RATs. A radio access network may include a different network element in a different system. For example, a network element of a radio access network in LTE and LTE-A includes an eNB (eNodeB, evolved NodeB), and network elements of a radio access network in WCDMA (Wideband Code Division Multiple Access, wideband code division multiple access) includes an RNC (Radio Network Controller) and a NodeB. Similarly, other radio networks such as WiMax (Worldwide Interoperability for Microwave Access) may also use a solution that is similar to that of the embodiments of the present invention, except that relevant modules in a base station system may be different, which is not limited in the embodiments of the present invention. But for ease of description, the following embodiments are described by taking an eNodeB as an example.

Furthermore, it should be understood that, in the embodiments of the present invention, a terminal may also be referred to as a user equipment (UE, User Equipment), a mobile station (MS), a mobile terminal, and so on. The terminal may perform communication with one or more core networks via a radio access network (RAN). For example, the terminal may be a mobile phone (or referred to as a “cellular” phone), or a computer with a communication function. For example, the terminal may also be a portable, pocket-type, handheld, computer-integrated, or vehicle-mounted mobile apparatus.

In LTE, a resource used for transmitting control signaling is referred to as a control channel element (CCE), where one CCE includes 36 resource elements (RE). A base station may perform encoding and modulation on control signaling according to a channel condition, for example, signal to interference plus noise ratio (Signal to Interference plus Noise Ratio, SINR), and map the control signaling to L CCEs for transmission, where Lε{1,2,4,8}.

Generally, the greater the number of CCEs occupied by the control signaling is (namely, the larger the value of L is), the better the transmission performance is, but the more the resource overheads of the occupied CCEs are. It is assumed that there are N_{CCE} CCEs in a transmission time interval (TTI), and because values of L of different UEs are different (channel conditions of different UEs are different), in order to fully use all CCEs to transmit more control signaling of a UE, in the LTE, the following formula (1) is defined to determine a logical number of a CCE, where the logical number of the CCE is used by the base station to transmit control signaling to the UE:

n_{CCE}(i)=L{(Y+m)mod └N_{CCE}/L┘}+i (1)

Y is a random number, values of Y of different TTIs are different, and in a certain TTI, values of Y of different UEs are different. m=( ), . . . , M^{(L)}−1 represents a serial number of a search space of the UE, and for cases that L is 1, 2, 4 and 8, values of M^{(L)} are 6, 6, 2 and 2 respectively, and therefore different values of L are corresponding to different numbers of search spaces. i=0, . . . , L−1 represents a serial number of a CCE in a certain search space. It can be seen from the formula (1) that, for a certain value of L, the base station may send a PDCCH in M^{(L)} search spaces, and each search space includes L CCEs.

The UE may detect a PDCCH on these CCEs obtained through calculation, so as to obtain control signaling. The UE does not know what a value of L determined by the base station is nor what a value of m is, which can only be determined through several attempts, and therefore this process is referred to as blind detection. A resource set formed by the L CCEs is also referred to as a search space, and one search space includes several continuous CCEs used for transmitting a PDCCH, which are referred to as a group of resources herein. In an LTE system, a search space includes a common search space (common search space) and a UE-specific search space (UE-specific search space). The common search space is generally CCEs whose logical numbers are 0 to 15, and all UEs perform blind detection in the common search space. The UE-specific search space is a specific search space of a certain UE, and a certain UE performs blind detection only on its specific search space.

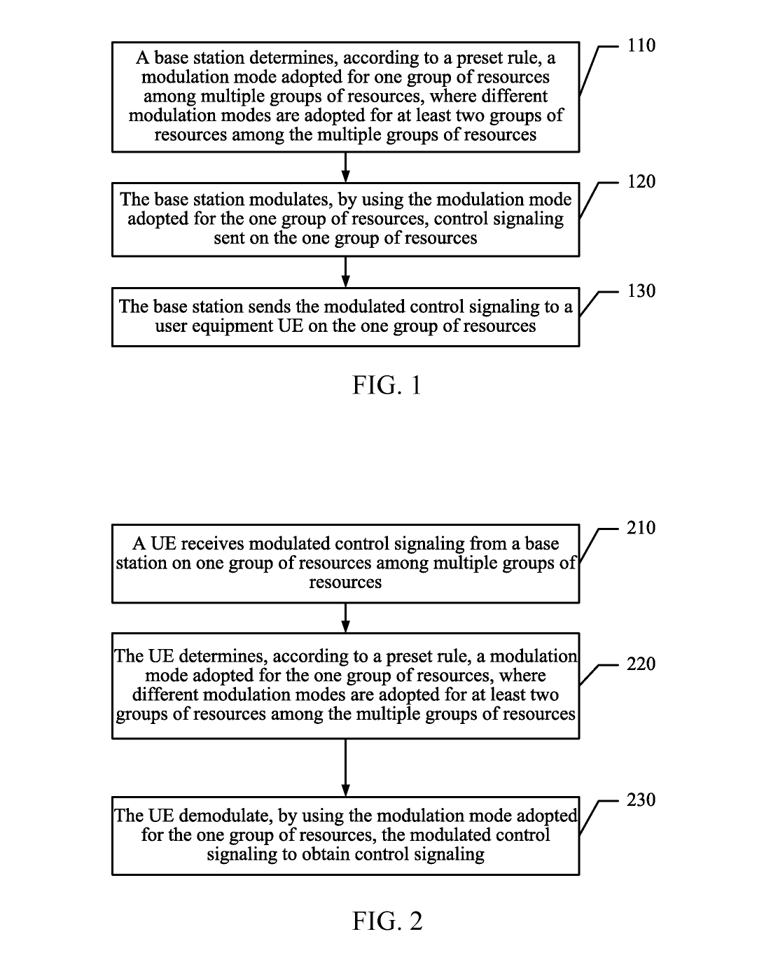

FIG. 1 is a flow chart of a method for transmitting control signaling according to an embodiment of the present invention. The method shown in FIG. 1 is executed by a base station.

110: A base station determines, according to a preset rule, a modulation mode adopted for one group of resources among multiple groups of resources, where different modulation modes are adopted for at least two groups of resources among the multiple groups of resources.

120: The base station modulates, by using the modulation mode adopted for the one group of resources, control signaling sent on the one group of resources.

130: The base station sends the modulated control signaling to a user equipment UE on the one group of resources.

For example, the preset rule is a mapping between different modulation modes and resources. A group of resources may include at least one CCE. The base station may select one group of resources from N (N>1) groups of available resources, and use the selected group of resources to send control signaling to the UE. According to the preset rule, if the base station sends the control signaling to the UE on a k^{th} (k=1, . . . , N) group of resources, the base station adopts a k^{th} modulation mode for performing modulation, where different modulation modes are adopted for at least two groups of resources. The base station may select and use, according to a channel condition, information amount of a PDCCH and/or other factors (for example, a modulation mode adopted for each of other groups of resources in an TTI that covers the group of resources), a modulation mode adopted for the group of resources to modulate control signaling sent on the group of resources. In other words, the base station selects the group of resources, for which the modulation mode is adopted, to send the control signaling according to the channel condition, the information amount of the PDCCH and/or other factors (for example, the modulation mode adopted for each of the other groups of resources in the TTI that covers the group of resources).

According to the embodiment of the present invention, multiple optional modulation modes may be provided for control signaling sent by a base station to a UE, so that the base station can flexibly select, according to a preset policy, a different modulation mode to process a PDCCH, thereby improving efficiency of transmitting control signaling.

In 110, the base station may determine, according to a logical number of a resource in the one group of resources, the modulation mode adopted for the one group of resources.

According to the embodiment of the present invention, the base station may determine, according to the magnitude or parity of a logical number of one resource in the one group of resources, or a result that is obtained by dividing a logical number of a first resource in the one group of resources by the number of resources included in the one group of resources, the modulation mode adopted for the one group of resources. The one resource in the one group of resources may be the first resource in the one group of resources.

For example, a modulation mode adopted for each group of resources is determined by a logical number of a certain resource (for example, a first resource) in the group of resources. For example, multiple groups of resources in one TTI may be classified into at least two types according to the magnitude of a logical number of a first resource in each group of resources, and each type is allocated with a different modulation mode; or multiple groups of resources in one TTI may be classified into two types according to the parity of a logical number of a first resource in each group of resources, and each type is configured with a different modulation mode. In a case that multiple resources are used to send control signaling, in order to avoid that the parity of logical numbers of first resources in groups of resources is the same, multiple groups of resources in one TTI may be classified according to the parity of a result obtained by dividing a logical number of a first resource in each group of resources by the number of resources included in the group of resources and rounding off the value after the division, and each type is configured with a different modulation mode. The determining, according to a logical number of a certain resource in each group of resources in one TTI, a modulation mode adopted for the group of resources, can ensure that different modulation modes are adopted for two groups of resources in at least one TTI, so that the base station can flexibly select a different modulation mode to process a PDCCH, thereby improving efficiency of transmitting control signaling.

Optionally, as another embodiment, in 110, the base station may determine, according to a serial number of a search space of the UE, the modulation mode adopted for the one group of resources, where the serial number of the search space of the UE is corresponding to a serial number of the one group of resources.

According to the embodiment of the present invention, the base station determines, according to the magnitude of the serial number of the one group of resources or the parity of the serial number of the one group of resources, the modulation mode adopted for the one group of resources, where the one group of resources is also referred to as a search space of the UE, and the serial number of the one group of resources is a serial number of the search space of the UE.

For example, the serial number of the search space of the UE is a serial number of each group of resources used by the UE to transmit control signaling in one TTI, and one group of resources is corresponding to one search space of the UE. One TTI covers at least more than two groups of resources (namely, at least more than two search spaces), and serial numbers of search spaces of the UE are continuous. Therefore, a method for determining, according to the magnitude or parity of a serial number of a search space of the UE, a modulation mode adopted for each group of resources is simple and can ensure that different modulation modes are adopted for at least two groups of resources.

Optionally, as another embodiment, in 110, the base station may determine, according to a configuration of a cell of the base station, the modulation mode adopted for the one group of resources.

According to the embodiment of the present invention, the configuration of the cell includes a cell identifier of the cell or a parameter that is configured by the base station for the cell.

For example, configurations of different cells of the base station (for example, cell identifiers or parameters that are configured by the base station for the cells) are different, and one cell does not know a configuration of another cell, and therefore the determining, according to a configuration of a cell, a modulation mode adopted for each group of resources enhances the security, and can also bring beneficial effects of interference randomization, that is, modulation modes adopted for the same resource of different cells are different. Therefore, mutual interference is also random, so that a probability of mutually generating strong interference is reduced.

Optionally, as another embodiment, in 110, the base station may determine, according to the number of resources included in the one group of resources, a random number, or time for transmitting the control signaling, the modulation mode adopted for the one group of resources, where the random number varies with a logical number of a first resource in each group of resources among the multiple groups of resources, a serial number of each group of resources among the multiple groups of resources, the number of resources included in each group of resources among the multiple groups of resources or the time for transmitting the control signaling.

For example, a modulation mode adopted for each group of resources is determined according to the number of resources in each group of resources used by the base station to send control signaling (for example, the number of CCEs in a group of CCEs), that is, different modulation modes are adopted for CCE groups that include different numbers of CCEs, for example, different values of L may be corresponding to different modulation modes.

For example, a different logical number of a first resource (for example, n_{cce}⁽⁰⁾) is corresponding to a different random number, and/or a different serial number of a search space (for example, m) is corresponding to a different random number, and/or the different number of resources (for example, L) is corresponding to a different random number, and/or a different TTI is corresponding to a different random number. The determining, according to such a random number, a modulation mode adopted for each group of resources can enhance the security and obtain beneficial effects of interference randomization.

For example, when the base station adopts a certain modulation mode to send a PDCCH to a certain UE, the base station may select and use a different resource in a different TTI, so that the interference of the PDCCH on another cell is randomized.

In 110, when the control signaling needs to be transmitted in a specific search space of the UE, the base station may determine, according to the preset rule, the modulation mode adopted for the one group of resources, where the specific search space of the UE includes a resource specially used for sending the control signaling of the UE.

For example, the embodiment of the present invention is applicable to a specific search space of the UE. Generally, a common search space needs to send control signaling to all UEs, and therefore it needs to be ensured that all the UEs can receive the control signaling, which imposes a higher requirement on stability. Therefore, the embodiment of the present invention is not applicable to the common search space. The embodiment of the present invention is applied to a specific search space of the UE, which can improve efficiency of transmitting a PDCCH to a certain UE.

In 110, when the number of resources included in the one group of resources is smaller than a first preset threshold, the base station may determine, according to the preset rule, the modulation mode adopted for the one group of resources.

For example, the embodiment of the present invention is applicable to a scenario that resources used by the base station to transmit control signaling are few. In other words, in a case that resources used for transmitting control signaling are few, a method of modulating control signaling by adopting different modulation modes according to the embodiment of the present invention is used; while in a case that resources used for transmitting control signaling are plentiful, a method of modulating control signaling by adopting a fixed QPSK modulation mode may be selected and used. That the resources used by the base station to transmit control signaling are plentiful (namely, a value of L is large) is generally applied to a case that a channel condition is poor. In this case, generally, efficiency of transmitting control signaling does not need to be improved. Therefore, in this case, if only transmission efficiency is considered, the method according to the embodiment of the present invention may not be used. For example, in the case of L=1 and 2, the method according to the embodiment of the present invention may be used; while in the case of L=4 and 8, a QPSK modulation mode may be used fixedly.

In 110, when a payload of the control signaling is greater than a second preset threshold, the base station may determine, according to the preset rule, the modulation mode adopted for the one group of resources.

For example, the embodiment of the present invention is applicable to a scenario that a payload (payload) of the control signaling is large. In an LTE system, a PDCCH has multiple formats, and different formats include different information, and generally, the amount of information transmitted in different formats is also different. For example, the amount of information included in a format used for scheduling the UE to perform uplink sending through a single antenna port is small, while the amount of information included in a format used for scheduling the UE to perform downlink receiving through a multi-antenna port is large. An information bit transmitted by the PDCCH is a payload. For a format of a small payload, generally, the QPSK may satisfy a transmission demand thereof. Therefore, the embodiment of the present invention is more applicable to control signaling with a large payload. Therefore, the method according to the embodiment of the present invention may be used when a payload is greater than a certain preset threshold. The threshold may be preset at the base station and the UE side, and therefore, a signaling overhead is reduced without a need of signaling notification.

Optionally, the base station and the UE may also classify all PDCCH formats into two groups. A first group does not use the method according to the embodiment of the present invention, and a second group uses the method according to the embodiment of the present invention. When sending a PDCCH format that belongs to the first group, the base station fixedly uses the QPSK for modulation, and the UE also detects, according to the QPSK, a PDCCH of the PDCCH format that belongs to the first group; and when sending a PDCCH format that belongs to the second group, the base station uses a flexible modulation mode in the present invention for modulation, and the UE also performs flexible detection correspondingly.

Optionally, as another embodiment, the base station may send activation signaling to the UE to notify the UE of the modulation mode that is adopted for the one group of resources and determined by the base station according to the preset rule.

For example, according to the embodiment of the present invention, when the base station sends the activation signaling to the UE, a method of adopting a different modulation mode to transmit control signaling according to the embodiment of the present invention may be used, and otherwise, a method of adopting a conventional fixed QPSK modulation mode with higher stability to transmit control signaling may be used according to a requirement, thereby improving stability and improving flexibility at the same time.

According to the embodiment of the present invention, the resource is a control channel element CCE that is corresponding to the UE.

For example, the CCE may specifically include multiple REs, and each PRB fixedly includes N CCEs. For example, each group of CCEs may include an integral multiple of 36 REs, and each PRB includes N CCEs, to facilitate scheduling and mapping of the base station, for example, N=4.

According to the embodiment of the present invention, the modulation mode includes: a QPSK modulation mode and a 16QAM mode.

The embodiment of the present invention is not limited thereto, and may also include other modulation modes, for example, 64QAM and BPSK. In a subsequent evolved system of the LTE, if these modulation modes continue to be used, the base station may directly use an existing modulation module to modulate a PDCCH, and the UE may also directly use an existing demodulation module to demodulate the PDCCH, which has beneficial effects of backward compatibility.

FIG. 2 is a flow chart of a method for transmitting control signaling according to another embodiment of the present invention. The method shown in FIG. 2 is executed by a UE. The method shown in FIG. 2 is corresponding to the method shown in FIG. 1, which is not described herein again.

210: A UE receives modulated control signaling from a base station on one group of resources among multiple groups of resources.

220: The UE determines, according to a preset rule, a modulation mode adopted for the one group of resources, where different modulation modes are adopted for at least two groups of resources among the multiple groups of resources.

230: The UE demodulate, by using the modulation mode adopted for the one group of resources, the modulated control signaling to obtain control signaling.

For example, corresponding to the method executed by the base station, according to the preset rule, the UE may demodulate the control signaling on a k^{th} group of resources according to a k^{th} modulation mode, so as to obtain the control signaling sent by the base station, where different modulation modes are adopted for at least two groups of resources. It should be noted that, 210 and 220 may be executed in parallel or executed in series, and a sequence of the execution may also be changed.

The technical solution may provide multiple optional modulation modes for control signaling sent by a base station to a UE, so that the base station can flexibly select, according to a preset policy, a different modulation mode to process a PDCCH, thereby improving efficiency of transmitting control signaling.

In 220, the UE determines, according to a logical number of a resource in the one group of resources, the modulation mode adopted for the one group of resources.

According to the embodiment of the present invention, the UE determines, according to the magnitude or parity of a logical number of a first resource in the one group of resources, or a result that is obtained by dividing a logical number of a first resource in the one group of resources by the number of resources in the one group of resources, the modulation mode adopted for the one group of resources.

Optionally, as another embodiment, in 220, the UE determines, according to a serial number of a search space of the UE, the modulation mode adopted for the one group of resources, where the serial number of the search space of the UE is corresponding to a serial number of the one group of resources.

According to the embodiment of the present invention, the UE determines, according to the magnitude of the serial number of the search space of the UE or the parity of the serial number of the search space of the UE, the modulation mode adopted for the one group of resources.

In 220, the UE determines, according to a configuration of a cell of the base station, the modulation mode adopted for the one group of resources.

According to the embodiment of the present invention, the configuration of the cell of the base station includes a cell identifier of the cell or a parameter that is configured by the base station for the cell.

Optionally, as another embodiment, in 220, the UE determines, according to the number of resources included in the one group of resources, a random number, or time for transmitting the control signaling, the modulation mode adopted for the one group of resources, where the random number is corresponding to a logical number of a first resource in each group of resources among the multiple groups of resources, a serial number of each group of resources among the multiple groups of resources, the number of resources included in each group of resources among the multiple groups of resources or the time for transmitting the control signaling.

Optionally, as another embodiment, in 220, when the control signaling needs to be transmitted in a specific search space of the UE, the UE determines, according to the preset rule, the modulation mode adopted for the one group of resources, where the specific search space of the UE includes a resource specially used by the UE to receive the control signaling.

Optionally, as another embodiment, in 220, when the number of resources included in the one group of resources is smaller than a first preset threshold, the UE determines, according to the preset rule, the modulation mode adopted for the one group of resources.

Optionally, as another embodiment, in 220, when a payload of the control signaling is greater than a second preset threshold, the UE determines, according to the preset rule, the modulation mode adopted for the one group of resources.

Optionally, as another embodiment, the UE receives activation signaling from the base station, where the activation signaling is used for notifying the UE of the modulation mode that is adopted for the one group of resources and determined by the base station according to the preset rule.

According to the embodiment of the present invention, the resource is a control channel element CCE.

According to the embodiment of the present invention, the modulation mode includes: a quadrature phase shift keying QPSK modulation mode and a 16-quadrature amplitude modulation QAM modulation mode.

The embodiment of the present invention is described in further detail in the following with reference to specific examples.

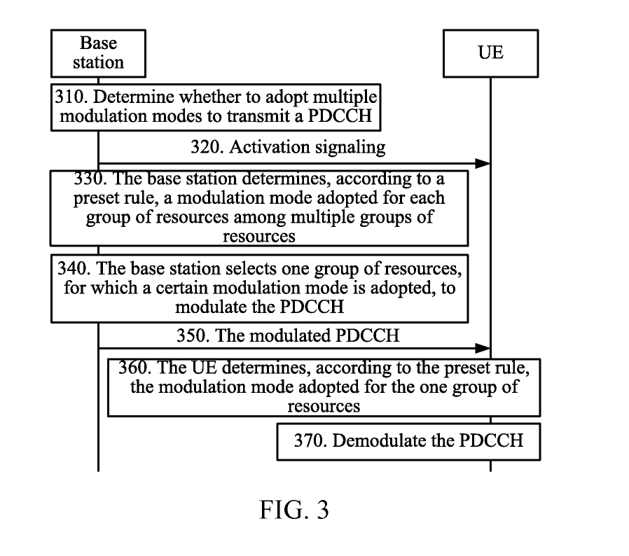

FIG. 3 is a schematic flow chart of a process of transmitting control signaling according to an embodiment of the present invention.

310: The base station determines whether multiple modulation modes are adopted to transmit a PDCCH on different groups of resources.

In the embodiment of the present invention, multiple modulation modes may be adopted to modulate control signaling (for example, a PDCCH) on different groups of resources, for example, a QPSK modulation mode is adopted for one group of resources, while a 16QAM modulation mode is adopted for another group of resources. However, in a case that stability is considered preferentially, a fixed QPSK modulation mode may also be adopted to modulate a PDCCH. In order to adapt to different demands, the base station may send activation signaling to the UE, for example, the activation signaling may be one bit. When the signaling is 0, it means that the base station does not use the method of adopting multiple modulation modes for different groups of resources according to the embodiment of the present invention; and when the signaling is 1, it means that the base station uses the method of adopting multiple modulation modes for different groups of resources according to the embodiment of the present invention. Correspondingly, the UE performs demodulation by adopting the fixed QPSK modulation mode or performs demodulation according to the method in the embodiment of the present invention.

320: The base station sends activation signaling to the UE, so as to notify the UE that the base station modulates the PDDCH by using the method in the embodiment of the present invention, namely, to notify the UE to demodulate the PDCCH by using the method in the embodiment of the present invention.

For example, the base station may send activation signaling to the UE in the case that it is determined that multiple modulation modes are adopted to transmit the PDCCH on different groups of resources, so as to notify the UE of a modulation mode that is adopted for different groups of resources and determined by the base station according to a preset rule.

310 and 320 in FIG. 3 are optional. According to the embodiment of the present invention, it may also be directly configured on the base station and the UE that different modulation modes are adopted for different groups of resources to transmit a PDCCH.

330: The base station determines, according to a preset rule, a modulation mode adopted for each group of resources among the multiple groups of resources.

For example, the preset rule may be a mapping between a modulation mode and a resource. The base station may determine corresponding modulation modes for different groups of resources according to the mapping. Various preset rules are described in detail in the following according to Embodiment 1 to Embodiment 6, which are not described herein again.

340: The base station selects one group of resources, for which a certain modulation mode is adopted, to modulate the PDCCH, so as to send the PDCCH.

For example, after the base station determines, according to a factor such as a channel condition, to use L (for example, L=1) resources to send the PDCCH, the base station may select a certain group of resources, for which a certain modulation mode is adopted, from M^{(L)} (for example, M^{(L)}=6) groups of resources according to the channel condition, information amount of the PDCCH and/or other factors (for example, a modulation mode adopted for each of other groups of resources in a TTI that covers the group of resources), so as to send the PDCCH. For example, when a channel condition of a PRB corresponding to the PDCCH is conducive to transmission between the PDCCH and a certain UE, one group of resources corresponding to a high-order modulation mode 16QAM may be selected to transmit the PDCCH to the UE, and in this way, efficiency of transmitting the PDCCH may be improved. The embodiment of the present invention is not limited thereto, and in specific implementation, in the embodiment of the present invention, another method for selecting a resource may be adopted.

For example, the base station modulates, by using the selected modulation mode, the PDCCH sent on the one group of resources.

350: The base station sends the modulated PDCCH to the UE.

For example, the base station sends the modulated PDCCH to the UE on the one group of resources.

360: The UE determines, according to the preset rule, the modulation mode adopted for the one group of resources.

For example, the UE obtains the PDCCH on the one group of resources through blind detection, and determines, according to the preset rule, the modulation mode adopted for the one group of resources.

370: The UE demodulates the PDCCH.

The UE demodulates, by using the determined modulation mode, the modulated PDCCH sent on the one group of resources.

According to the embodiment of present invention, the base station adopts different modulation modes when transmitting the PDCCH on different groups of resources, so that the base station may flexibly select a modulation mode of the PDCCH according to a channel condition, information amount of the PDCCH or other factors, and therefore efficiency of transmitting the PDCCH can be improved and an overhead of the PDCCH can be reduced.

In addition, a rule of adopting different modulation modes when a PDCCH is transmitted on different resources is preset, and the base station side and the UE side may use the same rule, so that the base station does not need to notify the UE of a specific rule, thereby saving a signaling overhead.

Several embodiments in which a modulation mode adopted for a resource is determined according to a preset rule are described in the following.

### Embodiment 1

According to a first embodiment of the present invention, a base station may determine, according to a logical number of a resource, a modulation mode adopted for the resource, namely, the modulation mode adopted for the resource is related to the logical number of the resource.

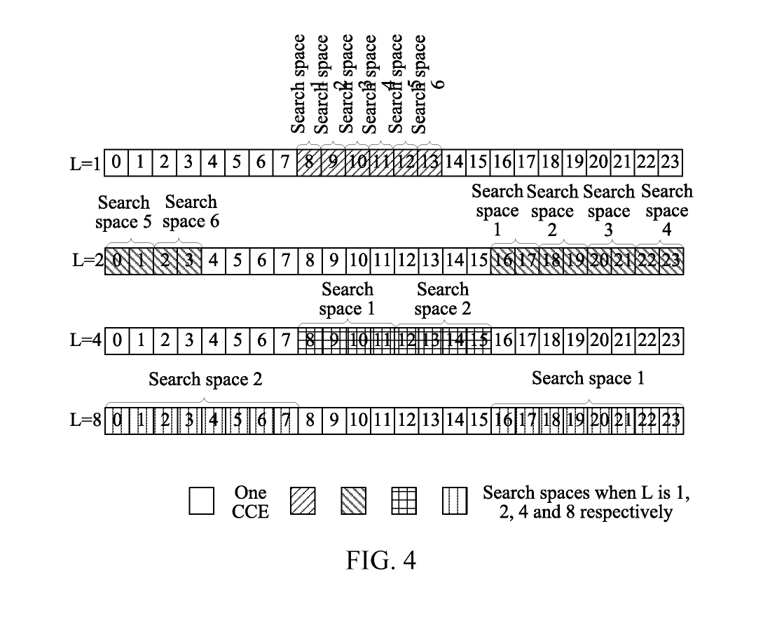

FIG. 4 is a schematic diagram according to a search space of a UE. Referring to FIG. 4, N_{CCE}=24, namely, in a TTI, there are 24 CCEs in total, logical numbers of the CCEs are 0 to 23, and Y=5048. For example, when L=1, serial numbers of the CCEs obtained through calculation according to the formula (1) include six groups of CCEs ({8}, {9}, {10}, {11}, {12}, {13}); when L=2, the serial numbers of the CCEs obtained through calculation according to the formula (1) include six groups of CCEs ({16,17}, {18,19}, {20,21}, {22,23}, {0,1}, {2,3}); when L=4, the serial numbers of the CCEs obtained through calculation according to the formula (1) include two groups of CCEs ({8˜11}, {12˜15}); and when L=8, the serial numbers of the CCEs obtained through calculation according to the formula (1) include two groups of CCEs ({16˜23}, {0˜7}).

For example, if the base station determines L=1, one group may be selected from the six groups of the CCEs at a first line in FIG. 4 to transmit control signaling to a UE; and if the base station determines L=4, any one group may be selected from the two groups of the CCEs at a third line in FIG. 4 to transmit the control signaling to the UE. In this way, the UE only needs to detect a PDCCH on all 16 groups of resources in FIG. 1 without a need of detecting other resources, thereby reducing the number of times of blind detection of the UE and reducing complexity of the UE.

Specifically, this embodiment may also be classified into the following several cases.

1: A modulation mode adopted to send a PDCCH on a group of resources may depend on the magnitude of a logical number of a first resource in the group of resources.

For example, in the case of L=1, when transmitting a PDCCH on a resource {8}, {9}, or {10}, the base station adopts a QPSK modulation mode; while when transmitting the PDCCH on a resource {11}, {12}, or {13}, the base station adopts a 16QAM modulation mode. Optionally, when transmitting the PDCCH on the resource {8}, {9}, or {10}, the base station adopts the 16QAM modulation mode; while when transmitting the PDCCH on the resource {11}, {12}, or {13}, the base station adopts the QPSK modulation mode. The base station may first determine, according to a channel condition, information amount of the PDCCH or other factors, a modulation mode that needs to be adopted to send the PDCCH, and then flexibly select and adopt the QPSK modulation mode on the CCE {8}, {9} or {10} or adopt the 16QAM modulation mode on the CCE {11}, {12} or {13} to transmit the PDCCH.

Similarly, when L takes other values (for example, L=2, 4 and 8), the base station may also adopt different modulation modes when transmitting the PDCCH on different groups of resources. For example, in the case of L=4, when transmitting the PDCCH on the CCEs {8˜11}, the base station adopts the QPSK modulation mode; while when transmitting the PDCCH on the CCEs {12˜15}, the base station adopts the 16QAM modulation mode. The base station may first determine an adopted modulation mode according to a channel condition, information amount of the PDCCH or other factors, and then flexibly select and adopt the QPSK modulation mode on the CCEs {8˜11} or adopt the 16QAM modulation mode on the CCEs {12˜15} to transmit the PDCCH.

Specifically, modulation modes adopted for different groups of resources may also be determined by using the following formula (2):

N_{modu}=└n_{cce}(0)/B^{(L)}┘ mod(N_{CCE}/B^{(L)}) (2)

N_{modu} represents a serial number of a modulation mode, for example, that a value of N_{modu} is 0 represents a first modulation mode, that a value of N_{modu} is 1 represents a second modulation mode, and so on; n_{cce}(0) is a logical number of a first resource in a group of resources; B^{(L)} is a number that can be exactly divided by N_{CCE}, └ ┘ represents rounding down, and mod represents a modulus operation (for example, 3 mod 2=1). For example, if N_{CCE}=24 and B^{(L)}=12, a result of N_{modu} can be only 0 or 1, which represents the first modulation mode and the second modulation mode respectively.

2: The parity of a logical number of a first resource in a group of resources determines a modulation mode adopted to send control signaling on the group of resources.

For example, when a logical number of a first resource in a group of resources is an odd number, the first modulation mode is adopted, while when the logical number of the first resource is an even number, the second modulation mode is adopted. The embodiment of the present invention is not limited thereto. For example, it may also be that when a logical number of a first resource in a group of resources is an odd number, the second modulation mode is adopted, while when the logical number of the first resource is an even number, the first modulation mode is adopted.

For example, in the case of L=1, when transmitting the PDCCH on the resource {8}, the base station adopts the QPSK modulation mode; while when transmitting the PDCCH on the resource {9}, the base station adopts the 16QAM modulation mode. Optionally, when transmitting the PDCCH on the resource {8}, the base station adopts the 16QAM modulation mode; while when transmitting the PDCCH on the resource {9}, the base station adopts the QPSK modulation mode.

Similarly, when L takes other values (for example, L=2, 4 and 8), the base station may also adopt different modulation modes when transmitting the PDCCH on different groups of resources, which is not described herein again.

Specifically, modulation modes adopted for different groups of resources may also be determined by using the following formula (3):

N_{modu}=n_{cce}(0)mod 2 (3)

In the case that the first modulation mode is adopted when the logical number of the first resource is an odd number, 1 represents the first modulation mode, and 0 represents the second modulation mode; while in the case that the first modulation mode is adopted when the logical number of the first resource is an even number, 0 represents the first modulation mode, and 1 represents the second modulation mode.

3: A result obtained by dividing a logical number of a first resource in a group of resources by L determines a modulation mode adopted to send control signaling on the resources.

When the base station uses multiple resources to send control signaling, results obtained through calculation according to the foregoing formulas (2) and (3) may be the same. For example, when L=4, serial numbers of available CCE resource groups include {8˜11} and {12˜15}, and for the two groups of resources, results obtained through calculation according to the formula (3) are both 0, namely, when L=4, only one modulation mode can be used.

Therefore, if a modulation mode is selected according to a result obtained by dividing a logical number of a first resource in a group of resources by L, the foregoing problem may be avoided. For example, modulation modes adopted for different groups of resources may also be determined by using the following formula (4):

N_{modu}={n_{cce}(0)/L} mod 2 (4)

In this way, when L=4, the serial numbers of the available CCEs include {8˜11} and {12˜15}, and for the two groups of resources, results obtained through calculation according to the formula (4) are 1 and 0 respectively. Therefore, in a scenario that the base station uses multiple resources to send the control signaling to the UE, the base station may also flexibly select a different modulation mode.

### Embodiment 2

According to an embodiment of the present invention, a base station may determine, according to a serial number of a search space of a UE, a modulation mode adopted for one group of resources, namely, the modulation mode adopted for the one group of resources is related to the serial number of the search space of the UE. The serial number of the search space of the UE is a value of m in the formula (1). In other words, if values of m are different, modulation modes adopted for resource groups corresponding to the values of m are also different.

Specifically, this embodiment may also be classified into the following cases.

1: A modulation mode adopted to send control signaling on a group of resources may depend on the magnitude of a serial number of a search space of the UE.

Specifically, modulation modes adopted for different groups of resources may also be determined by using the following formula (5):

N_{modu}=└m/T^{(L)}┘ mod [M^{(L)}/T^{(L)}] (5)

As mentioned in the foregoing, M^{(L)} represents the total number of search spaces when the base station uses L resources to send a PDCCH to the UE; and T^{(L)} is a number that can be exactly divided by M^{(L)}. For example, when L=1, M^{(L)}=6, and T^{(L)}=3 is set, it indicates that the first three search spaces adopt a first modulation mode, and the last three search spaces adopt a second modulation mode. Values of L are different, and values of T^{(L)} vary with the values of L. For example, when L=4, M^{(L)}=2, and T^{(L)}=1 is set, it indicates that the first one search space adopts the first modulation mode, and the last one search space adopts the second modulation mode. This design is relatively simple.

2: A modulation mode adopted to send control signaling on a group of resources may depend on the parity of a serial number of a search space of the UE.

For example, when a value of m is an odd number, the first modulation mode is adopted; and when the value of m is an even number, the second modulation mode is adopted. Optionally, when a value of m is an odd number, the second modulation mode is adopted; and when the value of m is an even number, the first modulation mode is adopted.

Specifically, modulation modes adopted for different groups of resources may also be determined by using the following formula (6):

N_{modu}=m mod 2 (6)

That is, when m is an odd number or an even number, modulation modes are different, namely, when N_{modu} is 1 or 0, modulation modes are different. Correspondence between a resource used for transmitting a control signal and a PRB is that: resources for transmitting a control signal are numbered according to a sequence of serial numbers of PRBs. For example, N_PRB PRBs in total are used for transmitting a PDCCH, where each PRB includes four resources used for transmitting a control signal, and resources on a first PRB are numbered as 1 to 4, resources on a second PRB are numbered as 5 to 8, and so on. In this case, by adopting the embodiment of the present invention, different modulation modes may be allocated on each PRB evenly, namely, each modulation mode is evenly distributed among all PRBs, so that the base station can flexibly select a different modulation mode on each PRB.

### Embodiment 3

According to an embodiment of the present invention, the base station may determine, according to the number of resources used for transmitting control signaling to a UE, a modulation mode adopted for one group of resources, namely, the modulation mode adopted for the one group of resources depends on the number of resources used by the base station to transmit control signaling to the UE.

The number of the resources used by the base station to transmit the control signaling is, for example, a value of L, namely, the number of CCEs used by the base station to send the control signaling. In other words, different values of L are corresponding to different modulation modes.

Specifically, modulation modes adopted for different groups of resources may also be determined by using the following formula (7):

N_{modu}=L mod 2 (7)

For example, when L is 1, a first modulation mode is used; and when L is 2, 4 or 8, a second modulation mode is used.

### Embodiment 4

According to an embodiment of the present invention, a base station may determine, according to a configuration of a cell of the base station, a modulation mode adopted for one group of resources, namely, the modulation mode adopted for the one group of resources depends on the configuration of the cell of the base station.

Specifically, this embodiment may also be classified into the following cases.

1: A modulation mode adopted for a certain resource depends on an ID of a cell of the base station.

Specifically, modulation modes adopted for different groups of resources may also be determined by using the following formula (8):

N_{modu}(m+Cell_ID)mod 2 (8)

In this way, rules of different cells are different, which enhances security, namely, if a UE of another cell does not know an ID of the cell, the UE does not know a modulation mode adopted by the cell to send a PDCCH, and therefore the PDCCH cannot be demodulated. Meanwhile, it can also bring beneficial effects of interference randomization, namely, modulation modes adopted by different cells on the same group of resources are different, so that mutual interference is also random, thereby statistically reducing a probability of strong interference on a PDCCH (for example, it is avoided that multiple cells adopt 16QAM for modulation on the same resource at the same time, thereby reducing mutual interference). In this case, the base station may determine, according to the ID of the cell of the base station and a value of m, the modulation mode adopted for the one group of resources.

2: A modulation mode adopted for a group of resources depends on a parameter configured by the base station.

Specifically, modulation modes adopted for different groups of resources may also be determined by using the following formula (9):

N_{modu}=(M+A)mod 2 (9)

A is a parameter configured by the base station to send signaling to the UE (for example, a serial number of a first PRB in all PRBs used for transmitting a PDCCH), and different cells may configure different parameters for their respective UEs, which can also enhance the security and bring beneficial effects of interference randomization. In this case, the base station may determine, according to the parameter configured by the base station and the value of m, the modulation mode adopted for the one group of resources.

### Embodiment 5

According to an embodiment of the present invention, the base station may determine, according to a random number, a modulation mode adopted for one group of resources, namely, a modulation mode adopted for a certain resource depends on a certain random number.

Specifically, modulation modes adopted for different groups of resources may also be determined by using the following formula (10):

N_{modu}(M+C)mod 2 (10)

C is a random number, for example, different values of ncce(0) and/or values of m and/or values of L and/or TTIs are corresponding to different values of C, which can also enhance security and bring beneficial effects of interference randomization. In this case, the base station may determine, according to a certain random number and a value of m, the modulation mode adopted for the one group of resources.

### Embodiment 6

According to an embodiment of the present invention, a base station may determine, according to time for transmitting control signaling to the UE, a modulation mode adopted for one group of resources, namely, a modulation mode adopted for a resource depends on time for the base station to transmit control signaling on the resource.

Specifically, modulation modes adopted for different groups of resources may also be determined by using the following formula (11):

N_{modu}(m+n_{ITI})mod 2 (11)

n_{TTI} represents a serial number of a TTI, and in this way, when the base station adopts a certain modulation mode to send a PDCCH to a certain UE, different resources are selected and used in different TTIs, so as to randomize interference of the PDCCH on other cells. In this case, the base station may determine, according to the serial number of the TTI and a value of m, the modulation mode adopted for the one group of resources.

It should be noted that, mappings between the multiple modulation modes and resources may be freely combined according to a requirement, thereby obtaining comprehensive beneficial effects. For example, the formula (11) is a combination of the second manner in Embodiment 2 and Embodiment 6.

The method for flexibly modulating a PDCCH according to the embodiment of the present invention provides multiple optional modulation modes for a base station to send a PDCCH to a UE, so that the base station flexibly selects, according to a channel condition, information amount of the PDCCH, or other factors, a different modulation mode to process the PDCCH, thereby improving efficiency of transmitting the PDCCH and reducing an overhead of the PDCCH.

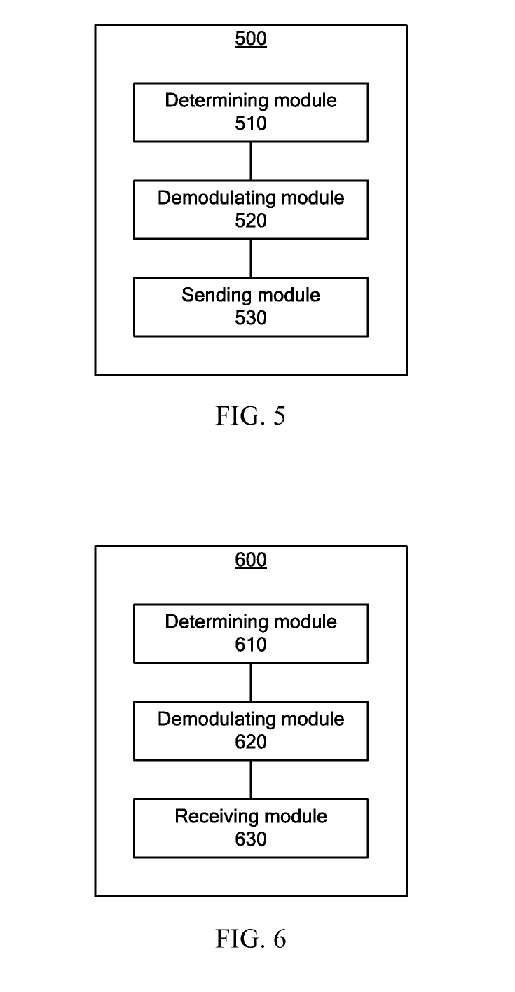

The method for transmitting control signaling according to the embodiment of the present invention is described in the foregoing. A base station and a user equipment according to the embodiment of the present invention are described in the following with reference to FIG. 5 and FIG. 6 respectively.

FIG. 5 is a schematic structural diagram of a base station 500 according to an embodiment of the present invention. The base station shown in FIG. 5 includes a determining module 510, a modulating module 520, and a sending module 530.

The determining module 510 determines, according to a preset rule, a modulation mode adopted for one group of resources among multiple groups of resources, where different modulation modes are adopted for at least two groups of resources among the multiple groups of resources. The modulating module 520 modulates, by using the modulation mode adopted for the one group of resources, control signaling sent on the one group of resources. The sending module 530 sends the modulated control signaling to a user equipment UE on the one group of resources.

The technical solution may provide multiple optional modulation modes for control signaling sent by a base station to a UE, so that the base station can flexibly select, according to a preset policy, a different modulation mode to process a PDCCH, thereby improving efficiency of transmitting control signaling.

According to the embodiment of the present invention, the determining module 510 determines, according to a logical number of a resource in the one group of resources, the modulation mode adopted for the one group of resources.

According to the embodiment of the present invention, the determining module 510 determines, according to a serial number of a search space of the UE, the modulation mode adopted for the one group of resources, where the serial number of the search space of the UE is corresponding to a serial number of the one group of resources.

Optionally, as another embodiment, the determining module 510 determines, according to a configuration of a cell of the base station, the modulation mode adopted for the one group of resources.

Optionally, as another embodiment, the determining module 510 determines, according to the number of resources included in the one group of resources, a random number, or time for transmitting the control signaling, the modulation mode adopted for the one group of resources, where the random number is corresponding to a logical number of a first resource in each group of resources among the multiple groups of resources, a serial number of each group of resources among the multiple groups of resources, the number of resources included in each group of resources among the multiple groups of resources or the time for transmitting the control signaling.

According to the embodiment of the present invention, when the control signaling needs to be transmitted in a specific search space of the UE, the determining module 510 determines, according to the preset rule, the modulation mode adopted for the one group of resources, where the specific search space of the UE includes a resource specially used for sending the control signaling of the UE.

Optionally, as another embodiment, when the number of resources included in the one group of resources is smaller than a first preset threshold, the determining module 510 determines, according to the preset rule, the modulation mode adopted for the one group of resources.

Optionally, as another embodiment, when a payload of the control signaling is greater than a second preset threshold, the determining module 510 determines, according to the preset rule, the modulation mode adopted for the one group of resources.

Optionally, as another embodiment, the sending module 530 further sends activation signaling to the UE, so as to notify the UE of the modulation mode that is adopted for the one group of resources and determined by the base station according to the preset rule.

References may be made to 210, 220 and 230 of the method shown in FIG. 2 for operations and functions of 510, 520 and 530 of the BS 500, which are not described herein again to avoid repetition.

FIG. 6 is a schematic structural diagram of a user equipment 600 according to an embodiment of the present invention. The user equipment shown in FIG. 6 includes a determining module 610, a demodulating module 620, and a receiving module 630.

The receiving module 630 is configured to receive modulated control signaling from a base station on one group of resources among multiple groups of resources. The determining module 610 is configured to determine, according to a preset rule, a modulation mode adopted for the one group of resources, where different modulation modes are adopted for at least two groups of resources among the multiple groups of resources. The demodulating module 620 is configured to demodulate, by using the modulation mode adopted for the one group of resources, the modulated control signaling to obtain control signaling.

The technical solution may provide multiple optional modulation modes for control signaling sent by a base station to a UE, so that the base station can flexibly select, according to a preset policy, a different modulation mode to process a PDCCH, thereby improving efficiency of transmitting control signaling.

According to the embodiment of the present invention, the determining module 610 determines, according to a logical number of a resource in the one group of resources, the modulation mode adopted for the one group of resources.

According to the embodiment of the present invention, the determining module 610 determines, according to a serial number of a search space of the UE, the modulation mode adopted for the one group of resources, where the serial number of the search space of the UE is corresponding to a serial number of the one group of resources.

According to the embodiment of the present invention, the determining module 610 determines, according to a configuration of a cell of the base station, the modulation mode adopted for the one group of resources.

Optionally, as another embodiment, the determining module 610 determines, according to the number of resources in the one group of resources, a random number, or time for transmitting the control signaling, the modulation mode adopted for the one group of resources, where the random number is corresponding to a logical number of a first resource in each group of resources among the multiple groups of resources, a serial number of each group of resources among the multiple groups of resources, the number of resources included in each group of resources among the multiple groups of resources or the time for transmitting the control signaling.

According to the embodiment of the present invention, when the control signaling needs to be transmitted in a specific search space of the UE, the determining module 610 determines, according to the preset rule, the modulation mode adopted for the one group of resources, where the specific search space of the UE includes a resource specially used by the UE to receive the control signaling.

Optionally, as another embodiment, when the number of resources included in the one group of resources is smaller than a first preset threshold, the determining module 610 determines, according to the preset rule, the modulation mode adopted for the one group of resources.

Optionally, as another embodiment, when a payload of the control signaling is greater than a second preset threshold, the determining module 610 determines, according to the preset rule, the modulation mode adopted for the one group of resources.

Optionally, as another embodiment, the receiving module 630 receives activation signaling from the base station, where the activation signaling is used for notifying the UE of the modulation mode that is adopted for the one group of resources and determined by the base station according to the preset rule.

References may be made to 310, 320 and 330 of the method shown in FIG. 3 for operations and functions of 610, 620 and 630 of the UE 600, which are not described herein again to avoid repetition.

An embodiment of the present invention further provides a communication system, which may include the base station 500 and the user equipment 600 in the foregoing embodiments.

According to the embodiments of the present invention, multiple optional modulation modes may be provided for a base station to send a PDCCH to a UE, so that the base station flexibly selects, according to a channel condition, information amount of the PDCCH or other factors, a different modulation mode to process the PDCCH, thereby improving efficiency of transmitting the PDCCH and reducing an overhead of the PDCCH. In addition, according to the embodiments of the present invention, security can be enhanced and beneficial effects of interference randomization can be brought.

Persons of ordinary skill in the art may be aware that, in combination with the examples described in the embodiments disclosed in this specification, units and algorithm steps may be implemented by electronic hardware, or a combination of computer software and electronic hardware. Whether the functions are performed by hardware or software depends on a particular application and a design constraint condition of the technical solutions. Persons skilled in the art may use different methods to implement the described functions for each particular application, but it should not be considered that such implementation goes beyond the scope of the present invention.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on multiple network units. A part or all of the units may be selected according to an actual need to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or part of the technical solutions may be implemented in the form of a software product. The computer software product is stored in a storage medium, and includes several instructions for instructing a computer device (which may be a personal computer, a server, or a network device) to perform all or a part of the steps of the method described in the embodiments of the present invention. The storage medium includes: any medium that can store program codes, such as a USB flash disk, a removable hard disk, a read-only memory (ROM, Read-Only Memory), a random access memory (RAM, Random Access Memory), a magnetic disk, or an optical disk.

The foregoing descriptions are merely specific embodiments of the present invention, but are not intended to limit the protection scope of the present invention. Any variation or replacement readily figured out by persons skilled in the art within the technical scope disclosed in the present invention shall all fall within the protection scope of the present invention. Therefore, the protection scope of the present invention shall be subject to the protection scope of the claims.

What is claimed is:

1. A method for transmitting control signaling, the method comprising:
determining, by a base station and according to a preset rule, a modulation mode adopted for one group of resources among multiple groups of resources, wherein different modulation modes are adopted for at least two groups of resources among the multiple groups of resources;
modulating control signaling sent on the one group of resources, the modulating performed by the base station using the modulation mode adopted for the one group of resources; and
sending, by the base station, the modulated control signaling to a user equipment UE on the one group of resources.

2. The method according to claim 1, wherein determining the modulation mode adopted for one group of resources among multiple groups of resources comprises determining, by the base station and according to a logical number of a resource comprised in the one group of resources, the modulation mode adopted for the one group of resources.

3. The method according to claim 2, wherein determining, by the base station and according to the logical number of a resource comprised in the one group of resources, the modulation mode adopted for the one group of resources comprises:
determining, by the base station and according to the magnitude or parity of a logical number of a first resource in the one group of resources or a result obtained by dividing the logical number of the first resource in the one group of resources by the number of resources comprised in the one group of resources, the modulation mode adopted for the one group of resources.

4. The method according to claim 1, wherein determining the modulation mode adopted for one group of resources among multiple groups of resources comprises determining, by the base station and according to a serial number of the one group of resources, the modulation mode adopted for the one group of resources.

5. The method according to claim 4, wherein determining, by the base station and according to the serial number of the one group of resources, the modulation mode adopted for the one group of resources comprises:
determining, by the base station and according to the magnitude of the serial number of the one group of resources or the parity of the serial number of the one group of resources, the modulation mode adopted for the one group of resources.

6. The method according to claim 1, wherein determining the modulation mode adopted for one group of resources among multiple groups of resources comprises determining, by the base station and according to a configuration of a cell of the base station, the modulation mode adopted for the one group of resources.

7. A method for transmitting control signaling, the method comprising:
receiving, by a user equipment UE, modulated control signaling from a base station on one group of resources among multiple groups of resources;
determining, by the UE and according to a preset rule, a modulation mode adopted for the one group of resources, wherein different modulation modes are adopted for at least two groups of resources among the multiple groups of resources; and
demodulating, by the UE by using the modulation mode adopted for the one group of resources, the modulated control signaling to obtain control signaling.

8. The method according to claim 7, wherein determining the modulation mode adopted for the one group of resources comprises determining, by the UE and according to a logical number of the one group of resources, the modulation mode adopted for the one group of resources.

9. The method according to claim 8, wherein determining, by the UE and according to a logical number of the one group of resources, the modulation mode adopted for the one group of resources comprises determining, by the UE and according to the magnitude or parity of a logical number of a first resource in the one group of resources, or a result obtained by dividing the logical number of the first resource in the one group of resources by the number of resources in the one group of resources, the modulation mode adopted for the one group of resources.

10. The method according to claim 7, wherein determining the modulation mode adopted for the one group of resources comprises determining, by the UE and according to a serial number of the one group of resources, the modulation mode adopted for the one group of resources.

11. A base station, comprising:
a determining module, configured to determine, according to a preset rule, a modulation mode adopted for one group of resources among multiple groups of resources, wherein different modulation modes are adopted for at least two groups of resources among the multiple groups of resources;
a modulating module, configured to modulate, by using the modulation mode adopted for the one group of resources, control signaling sent on the one group of resources; and
a sending module, configured to send the modulated control signaling to a user equipment UE on the one group of resources.

12. The base station according to claim 11, wherein the determining module determines, according to a logical number of a resource comprised in the one group of resources, the modulation mode adopted for the one group of resources.

13. The base station according to claim 11, wherein the determining module determines, according to a serial number of the one group of resources, the modulation mode adopted for the one group of resources.

14. The base station according to claim 11, wherein the determining module determines, according to a configuration of a cell of the base station, the modulation mode adopted for the one group of resources.

15. The base station according to claim 11, wherein the determining module determines, according to the number of resources comprised in the one group of resources, a random number, or time for transmitting the control signaling, the modulation mode adopted for the one group of resources, wherein the random number is corresponding to a logical number of a first resource in each group of resources among the multiple groups of resources, a serial number of each group of resources among the multiple groups of resources, the number of resources comprised in each group of resources among the multiple groups of resources or the time for transmitting the control signaling.

16. A user equipment, comprising:
a receiving module, configured to receive modulated control signaling from a base station on one group of resources among multiple groups of resources;
a determining module, configured to determine, according to a preset rule, a modulation mode adopted for the one group of resources, wherein different modulation modes are adopted for at least two groups of resources among the multiple groups of resources; and
a demodulating module, configured to demodulate, by using the modulation mode adopted for the one group of resources, the modulated control signaling to obtain control signaling.

17. The user equipment according to claim 16, wherein the determining module determines, according to a logical number of a resource comprised in the one group of resources, the modulation mode adopted for the one group of resources.

18. The user equipment according to claim 16, wherein the determining module determines, according to a serial number of the one group of resources, the modulation mode adopted for the one group of resources.

19. The user equipment according to claim 16, wherein the determining module determines, according to a configuration of a cell of the base station, the modulation mode adopted for the one group of resources.

20. The user equipment according to claim 16, wherein the determining module determines, according to the number of resources comprised in the one group of resources, a random number, or time for transmitting the control signaling, the modulation mode adopted for the one group of resources, wherein the random number is corresponding to a logical number of a first resource in each group of resources among the multiple groups of resources, a serial number of each group of resources among the multiple groups of resources, the number of resources comprised in each group of resources among the multiple groups of resources or the time for transmitting the control signaling.
